(19) United States
(12) Patent Application Publication
(10) Pub. No.: US 2026/0213825 A1
(43) Pub. Date: Jul. 23, 2026

(54) USER EQUIPMENT MOBILITY MANAGEMENT

(71) Applicant: ZTE CORPORATION, Shenzhen, Guangdong (CN)

(72) Inventors: Zhuang LIU, Shenzhen (CN); Jianxun AI, Shenzhen (CN); Jiren HAN, Shenzhen (CN); Man ZHANG, Shenzhen (CN); Dapeng LI, Shenzhen (CN)

(21) Appl. No.: 19/144,038

(22) PCT Filed: Mar. 29, 2023
(86) PCT No.: PCT/CN2023/084795

§ 371 Date: Jun. 27, 2025

(51) Int. Cl. H04B 7/06; H04W 36/00

(52) U.S. Cl. CPC H04B 7/06952; H04W 36/0072

(57) ABSTRACT

In wireless communication, mobile device movement can be better management to ensure communications are maintained. A user equipment (UE) may have improved mobility management. Mobility assistance information may be communicated for managing the UE mobility. The mobility assistance information may include a target cell indication, a delivery inquiry indication, or a serving beam measurement configuration.

### TECHNICAL FIELD

This document is directed generally to wireless communications. More specifically, in a mobile device communications system, there may be improved management of user equipment (UE) mobility.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications in which a user equipment (UE) has mobility with improved management. Mobility assistance information may be communicated for managing UE mobility. The mobility assistance information may include a target cell indication, a delivery inquiry indication, or a serving beam measurement configuration.

In one embodiment, a wireless communication method includes receiving, at a basestation distributed unit (DU), a target cell indication; and activating, by the basestation DU, one or more beams indicated by the target cell indication. The target cell indication comprises a synchronization signal block (SSB) index list to activate. The target cell indication is provided by a basestation centralized unit (CU). The basestation CU receives the one or more beams that were successfully activated from the basestation DU. The SSB index list to activate is included in a handover request message from another basestation. The successfully activated beam(s) are included in a handover acknowledge message response by a basestation centralized unit (CU). The receiving and activating are part of a context setup or context modification communications.

In another embodiment, a wireless communication method includes receiving, at a basestation distributed unit (DU), a delivery inquiry indication information sent by a basestation centralized unit (CU) that indicates to report whether a user equipment (UE) can receive broadcast information in a target cell; and determining, by the basestation DU, whether a user equipment (UE) can receive broadcast information in a target cell based on the delivery inquiry indication information. The delivery inquiry indication information comprises a system information block (SIB) delivery inquiry indication. The method includes sending, by a basestation DU, a broadcast receipt indication to a basestation CU, wherein the broadcast receipt indication indicates whether the UE can receive the broadcast information in the target cell or whether dedicated signaling for SIB delivery is needed. The basestation CU determines a type of SIB delivery to the UE based on the broadcast receipt indication. The basestation CU delivers at least one of SIB block information to the UE via dedicated RRC signaling after a successful handover. The receiving and sending are part of a context setup or context modification communications.

In another embodiment, a wireless communication method includes receiving, at a basestation distributed unit (DU), a serving beam measurement configuration; and recording serving synchronization signal block (SSB) information based on the serving beam measurement configuration. The method includes at least one of: an indication to request reporting of a last serving SSB; an indication to request reporting one or more SSBs serving the UE in a defined period time; or an indication to request reporting of a UE staying time for each serving SSB. The basestation DU reports the recorded serving SSB information to a basestation centralized unit (CU). When the serving beam measurement configuration is not received, the basestation DU reports on a one last serving SSB index to the basestation CU. The basestation DU includes the report in an UE CONTEXT RELEASE COMPLETE message during the UE context release procedure. The receiving is during user equipment (UE) context setup or UE modification.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows an embodiment of user equipment (UE) intra-DU mobility.

FIG. 5 shows an embodiment of user equipment (UE) intra-CU and inter-DU mobility.

FIG. 6 shows an embodiment of user equipment (UE) inter-CU mobility.

FIG. 7 shows example mobility assistance information.

FIG. 8 shows example serving beam measurement configurations.

FIG. 9 shows an embodiment of UE mobility between different basestations with target cell indication information.

FIG. 10 shows an embodiment of UE mobility between different basestations with delivery inquiry indication information.

FIG. 11 shows an embodiment of UE mobility between different basestations with serving beam measurement configuration information.

FIG. 12 shows an embodiment of UE mobility within intra-DU basestations with target cell indication information.

FIG. 13 shows an embodiment of UE mobility within intra-DU basestations with delivery inquiry indication information.

FIG. 14 shows an embodiment of UE mobility within intra-DU basestations with serving beam measurement configuration information.

FIG. 15 shows an embodiment of paging a UE with restricted mobility within intra-DU basestations.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

A user equipment (“UE”) device may move between nodes or cells in which case a handover or a change/addition operation may occur to improve network reliability for the UE as it moves. The movement may be from a source cell to a target cell based on a number of potential target cells that are referred to as candidates. The movement between cells may also include a number of target cells that are potential candidate cells. A conditional handover (“CHO”) and a conditional PSCell addition/change (“CPAC”) are described below. The CPAC may include a conditional PSCell change (“CPC”) and/or a conditional PSCell addition (“CPA”). A conditional handover (“CHO”) can reduce handover interruption time and improve mobility reliability. A CHO is a handover that is executed by the UE when one or more execution conditions are met. The UE can evaluate the execution condition(s) upon receiving the CHO configuration, and can stop evaluating the execution condition(s) once the handover is triggered. The CHO configuration may include a candidate PCell configuration generated by a candidate target node and the corresponding execution condition(s) for that candidate cell.

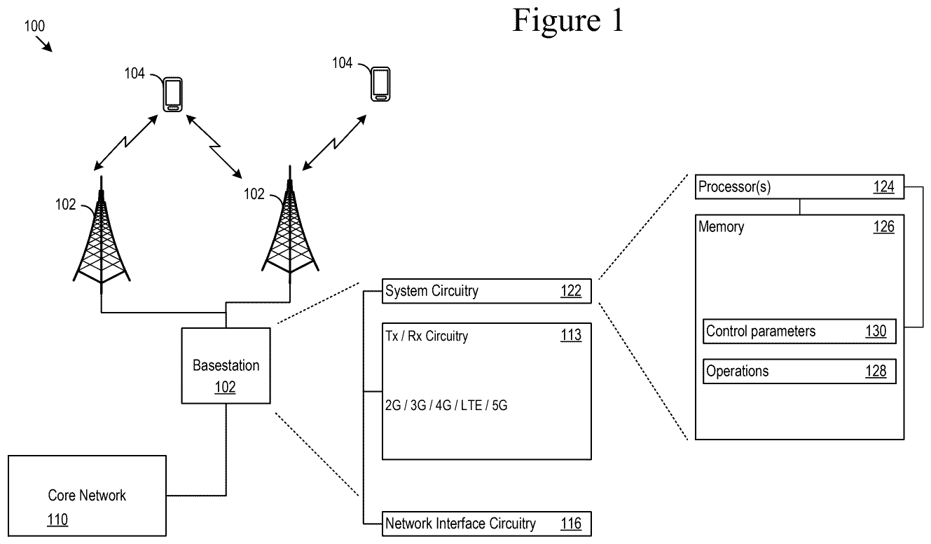

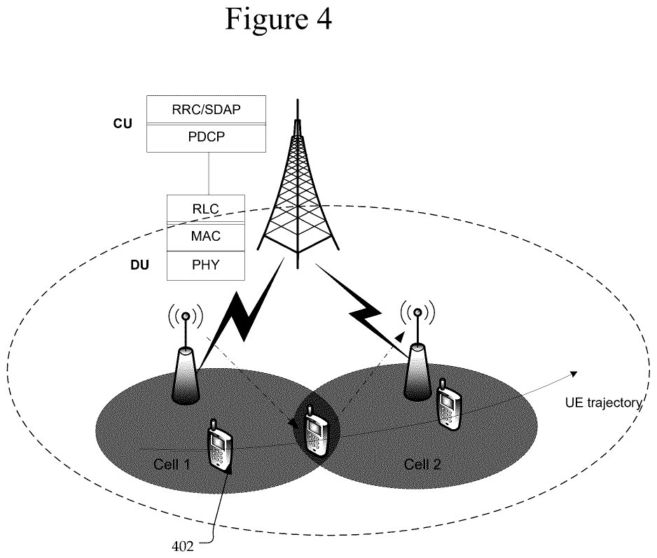

A conditional PSCell addition/change (“CPAC”) may include the UE having a network configuration for initiating access to a candidate PSCell, either to consider whether the PSCell is suitable for SN addition or SN change including an intra-SN change. This consideration may be based on configured condition(s). The UE in the wireless network can operate in dual connectivity (“DC”), including intra-E-UTRA DC or Multi-Radio DC (“MR-DC”). In the example of intra-E-UTRA DC, both the MN and SN provide E-UTRA access. While in the example of MR-DC, one node may provide new radio (“NR”) access and the other one provides either E-UTRA or NR access. As described below with respect to FIGS. 1-6, a network provider may include a number of network nodes (i.e. basestations) for providing network access to a user equipment (“UE”) device. The network nodes are referred to as basestations in some embodiments. FIGS. 4-6 illustrate cell mobility in which the UE device moves between cells. Control signaling may be used to facilitate this mobility. Mobility may be referred to as handover (HO) or a handover process.

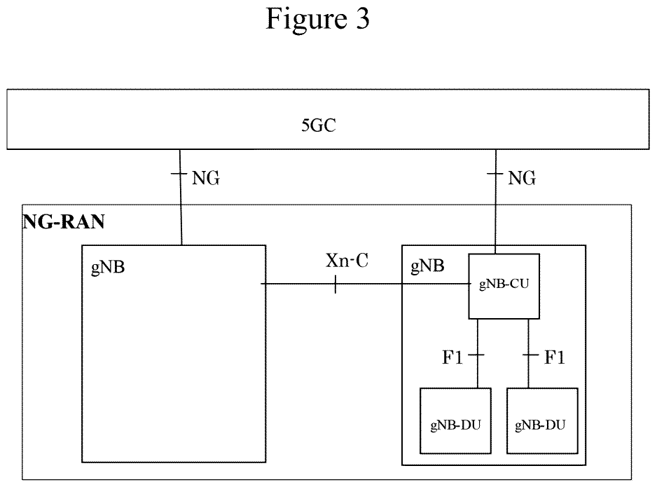

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

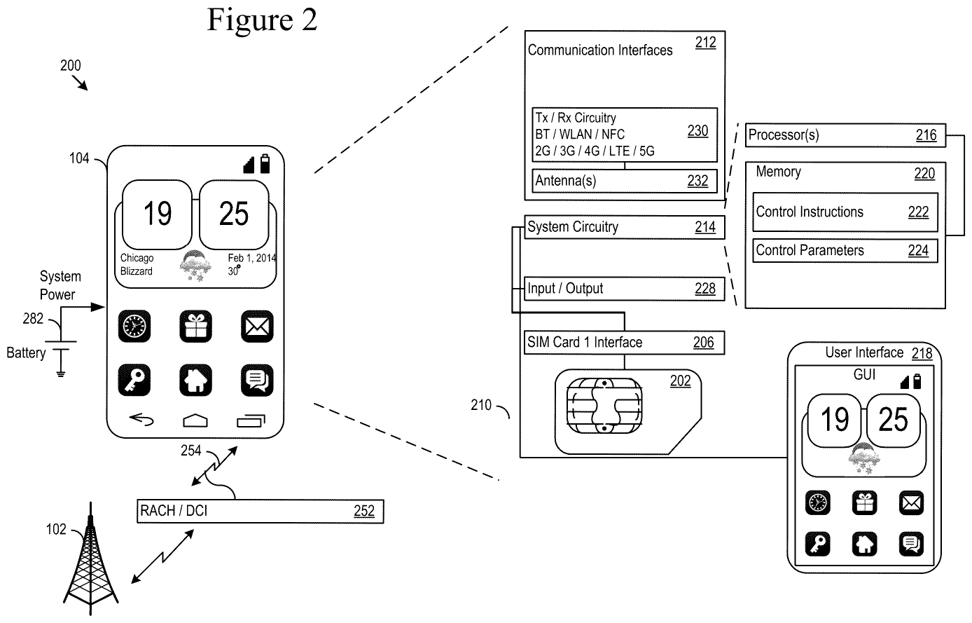

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM 1 202. Electrical and physical interface 206 connects SIM 1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U(MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as have one CU that is connected to two DUs via an F1 interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

The inter-cell mobility described herein may occur in a number of different examples. There may be intra-DU mobility where a UE changes cells within a single DU. Examples of intra-DU mobility include: 1) PCell change within one DU (may also include PCell change with SCell change); 2) PSCell change within one DU (may also include PSCell change with SCell change); and 3) PCell change within one DU with PSCell change within one DU (may also include SCell change within one cell group). In another mobility embodiment, there may be intra-CU and inter-DU mobility where a UE changes cells between different DUs but within a single CU. Examples of intra-CU and inter-DU mobility include: 1) PCell change across DU but within one CU (may also include PCell change with SCell change); and 2) PSCell change across DU but within one CU (may also include PSCell change with SCell change). In another mobility embodiment, there may be inter-CU mobility where a UE changes cells between different CUs. Examples of inter-CU mobility include: 1) PCell change across CU (may also include PCell change with SCell change); and 2) PSCell change across CU (may also include PSCell change with SCell change). In another embodiment, there may be a SCell change/addition and this example may include the SCell addition/change within one cell group. FIGS. 4-6 illustrate embodiments of UE mobility between cells.

FIG. 4 shows an embodiment of user equipment (UE) intra-DU mobility. The basestation may include a CU and at least one DU. In this embodiment, there is a single DU shown that has multiple cells. Both Cell 1 and Cell 2 are from the single DU. In this example, the UE 402 can move from Cell 1 to Cell 2 and is depicted in FIG. 4 with a UE trajectory from Cell 1 to Cell 2. The mobility from cells may occur when the UE 402 is in a position between the two cells and making its way to the third position within Cell 2. This is intra-DU mobility because the UE is moving cells within a single DU.

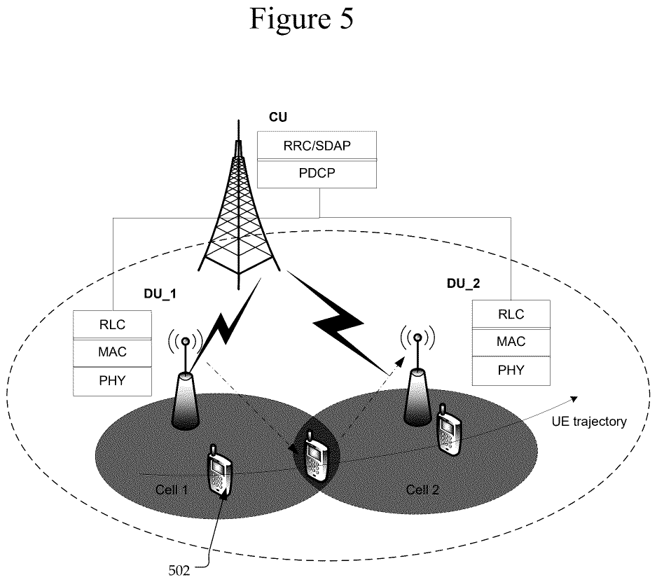

FIG. 5 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell 1 and DU_2 is providing Cell 2. In this example, the UE 502 can move from Cell 1 to Cell 2 and is depicted in FIG. 5 with a UE trajectory from Cell 1 to Cell 2 which also results in a transition from DU_1 to DU_2. The mobility from cells may occur when the UE 402 is in a position between the two cells and making its way to the third position within Cell 2. This is intra-CU mobility because the UE is moving cells within a single CU. However, this is also inter-DU mobility because the UE is moving between different DUs.

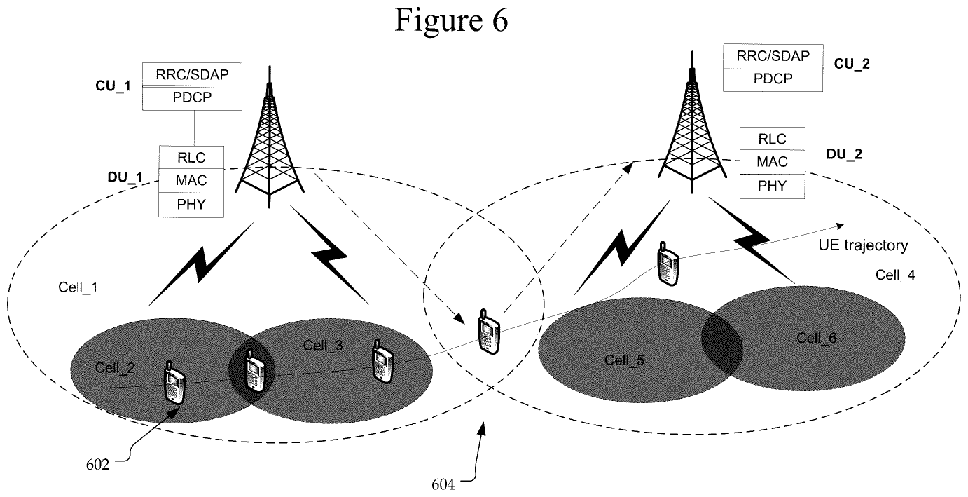

FIG. 6 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 602 passes from Cell_2 to Cell_3 to an inter-CU position 604 (between CU_1 and CU_2) to Cell_5 and Cell_6. As the UE moves, the mobility may change cells as shown and may transition between a number of cells. Because the UE 602 (at the inter-CU position 604) switches cells from CU_1 to CU_2, this transition is referred to as inter-CU mobility.

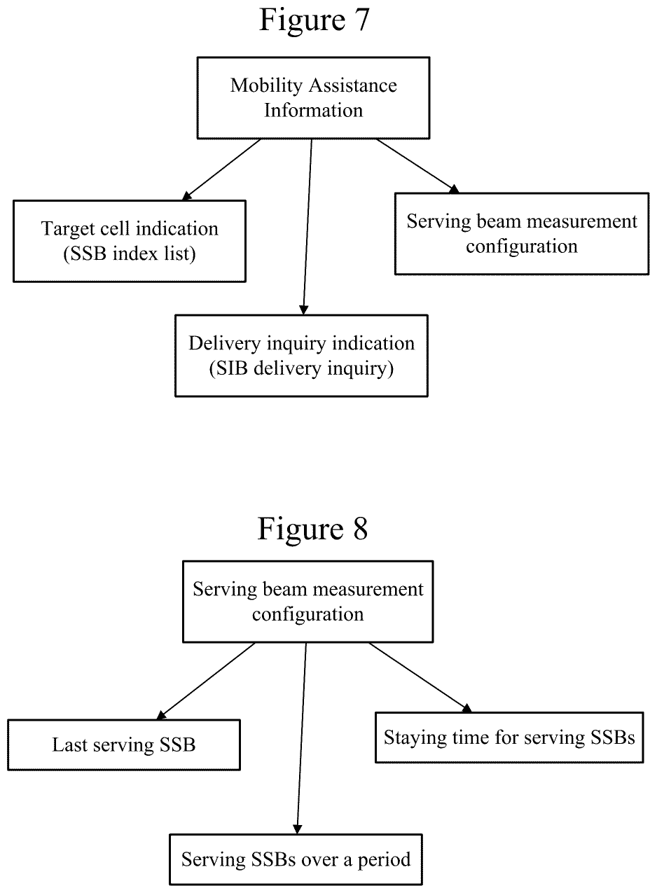

The embodiments described below with respect to FIGS. 7-15, illustrate embodiments that improve a quality of user services. When the UE accesses a dedicated downlink Bandwidth Part (DL BWP) in a target cell upon handover, the first activated BWP may include a cell defining Synchronization Signal Block (CD-SSB). Alternatively, it may be the initial BWP that is associated with CD-SSB. The UE can receive broadcast information in the target cell after successful handover. However, for a non-cell defining Synchronization Signal Block (NCD-SSB) common search space (CSS) may not be configured as a resource for cell broadcast system information receiving. During the UE mobility, if the UE's first activated BWP in the target cell is associated with a NCD-SSB and CSS is not configured, the UE may not receive broadcast information in the target cell after a successful handover. In some embodiments described below, the basestation may decide whether to deliver the broadcast information to UE via dedicated RRC message. Specifically, for a CU/DU split basestation, the basestation-DU may know whether the specific NCD-SSB is configured with CSS or not, while the basestation-CU may not know the first active DL BWP of UE, or whether the first active DL BWP is associated with a NCD-SSB in which CSS is not configured. The basestation-CU may not be able to decide whether to deliver the broadcast information to UE via dedicated RRC message. This embodiment is addressed with the transmission of certain mobility assistance information, such as delivery inquiry indication, described below.

In another embodiment, during the UE mobility, if the UE is move to an area with deactivated beam(s) coverage in the target cell during the handover, the random access node (RAN) may fail to handover the UE to the target cell. The basestation may switch off some beams of the cell based on the cell load or user distribution in area. A basestation may notify its neighbor basestations using the NG-RAN NODE CONFIGURATION UPDATE message with the list of cells and beam(s) (indicated by SSB index(s)) with activation/deactivation status and modified coverage included. During the UE mobility, if the UE is moved to an area of some deactivated beam(s) coverage in target cell during the handover, the RAN may fail to handover the UE to the target cell. This embodiment is addressed with the transmission of certain mobility assistance information, such as target cell indication, described below.

In another embodiment, for UE mobility limited to a restricted area, if the basestation knows the latest position of the UE when the UE is released (e.g. beam information), there may not be a need to page the UE on all SSBs in the paging cell. However, for a CU/DU split basestation, the basestation-CU may not be aware of the serving beam information when the UE is released. In that instance, the UE may not be paged quickly and energy consumption on the RAN may be lost. This embodiment is addressed with the transmission of certain mobility assistance information, such as serving beam measurement configuration, described below.

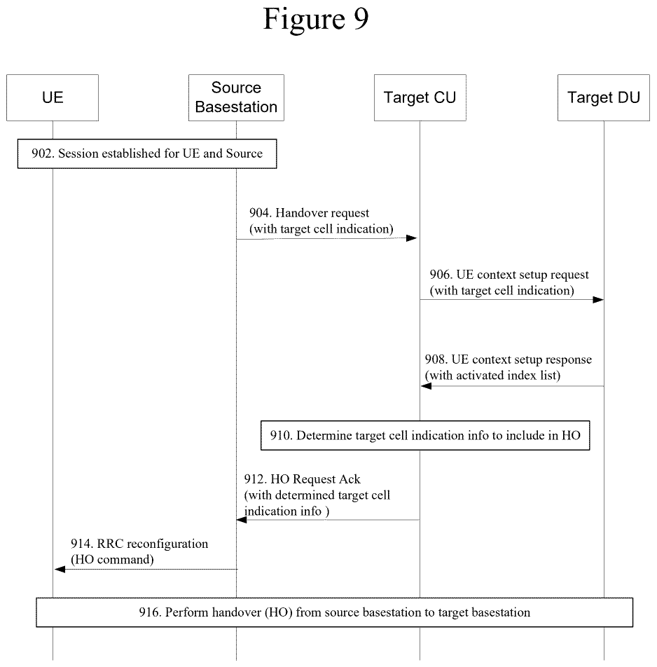

FIGS. 7-8 illustrates example mobility assistance information that may be communicated in the embodiments shown in FIGS. 9-15. FIG. 7 shows example mobility assistance information. The mobility assistance information may include a target cell indication, a delivery inquiry indication, and/or serving beam measurement configuration. The target cell indication may also be referred to as a SSB Index List To Activate. This may indicate the target cell which beam(s) is/are needed to switch on. The delivery inquiry indication may include a System Information Block (SIB) Delivery Inquiry Indication, which requests reporting on whether the UE can receive broadcast information in target cell or not. The Serving Beam Measurement Configuration may include information about a beam.

FIG. 8 shows example serving beam measurement configurations. The Serving Beam Measurement Configuration may include an indication to request reporting of a last serving SSB. In another example, Serving Beam Measurement Configuration may include an indication to request reporting of one or more SSBs serving the UE in a period of time. In another example, Serving Beam Measurement Configuration may include an indication to request reporting the UE staying time in each reported serving SSB. The Mobility Assistance Information of FIG. 7 and the Serving Beam Measurement Configuration of FIG. 8 is further described with respect to the communication embodiments described below.

FIG. 9 shows an embodiment of UE mobility between different basestations with target cell indication information. In block 902, the UE establishes a Packet Data Unit (PDU) session between the UE, the source basestation and the target CU basestation. During the UE mobility, the source basestation identifies the target basestation for handover, and the source basestation is aware of which beam(s) are switched off in the target cell of target basestation. If the source basestation assumes the UE can move to the area of some deactivated beam(s) coverage in the target cell, then the basestation sends the handover request message via Xn interface to the target basestation in block 904. The handover request may include the target cell indication as the SSB Index List To Activate in the message.

After receiving the handover request message, the basestation-CU of the target basestation sends a UE CONTEXT SETUP REQUEST message to the target basestation-DU in block 906. The target cell locates the target basestation-DU. This is a request for allocating resources for the UE handover and setup UE context, and may include the Mobility Assistance Information in the message. The Mobility Assistance Information examples are described with respect to FIGS. 7-8 and illustrated separately in FIGS. 9-11. In block 906, the request includes the target cell indication.

After receiving the UE CONTEXT SETUP REQUEST message, the basestation-DU allocates resource for this UE in the target cell, and establishes UE context in the basestation-DU. With the target cell indication information (SSB Index List To Activate) received, the basestation-DU shall switch on the beams indicated by this information, and include the Successfully Activated SSB Index List (to indicate which beam(s) is/are successfully activated) in the UE CONTEXT SETUP RESPONSE message in block 908. With this information, the rate of successful handovers can be improved.

After receipt of the UE CONTEXT SETUP RESPONSE message, if the target cell indication (Successfully Activated SSB Index List) is received, the basestation-CU decides whether to include the target cell indication (Successfully Activated SSB Index List) in block 910. When decided, this information is included in the HANDOVER REQUEST ACKNOWLEDGE message in block 912. In block 914, the target basestation sends the RRC RECONFIGURATION message to the UE. The HO command may include the broadcast information (e.g., at least one of the SIB information) of target cell in HO command information within the message. In this way, the UE can receive the broadcast information via the RRC message (e.g., RRC RECONFIGURATION), even if the UE cannot receive these information broadcast by the target cell. In block 916, the handover (HO) is performed for the UE from source basestation to the target basestation.

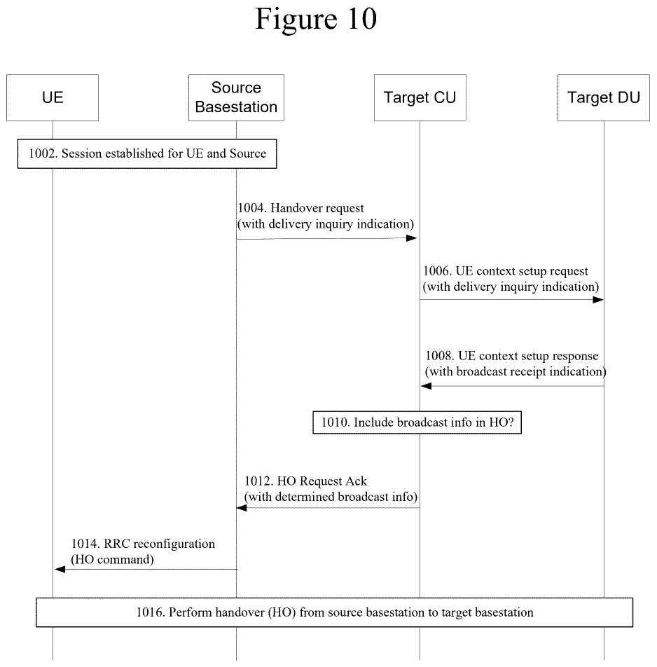

FIG. 10 shows an embodiment of UE mobility between different basestations with delivery inquiry indication information. In block 1002, the UE establishes a Packet Data Unit (PDU) session between the UE, the source basestation and the target CU basestation. During the UE mobility, the source basestation identifies the target basestation for handover, and the source basestation is aware of which beam(s) are switched off in the target cell of target basestation. If the source basestation assumes the UE can move to the area of some deactivated beam(s) coverage in the target cell, then the basestation sends the handover request message via Xn interface to the target basestation in block 1004. The handover request may include the delivery inquiry indication (SIB Delivery Inquiry Indication) in the message.

After receiving the handover request message, the basestation-CU of the target basestation sends a UE CONTEXT SETUP REQUEST message to the target basestation-DU in block 1006. The target cell locates the target basestation-DU. This is a request for allocating resources for the UE handover and setup UE context, and may include the Mobility Assistance Information in the message. The Mobility Assistance Information examples are described with respect to FIGS. 7-8 and illustrated separately in FIGS. 9-11. In block 1006, the request includes the delivery inquiry indication (SIB Delivery Inquiry Indication).

After receiving the UE CONTEXT SETUP REQUEST message, the basestation-DU allocates resource for this UE in the target cell, and establishes UE context in the basestation-DU. The context setup response in block 1008 may include a broadcast receipt indication. With the delivery inquiry indication (SIB Delivery Inquiry Indication) information received, the basestation-DU shall include the SIB Delivery Needed Indication (to indicate whether the UE can receive the broadcast information in target cell or not, or to indicate whether the dedicated signaling for SIB delivery is needed or not) in the UE CONTEXT SETUP RESPONSE message in block 1008.

After receipt of the UE CONTEXT SETUP RESPONSE message, if the delivery inquiry indication (System Information Block (SIB) Delivery Needed Indication) is received, the basestation-CU decides to deliver or include the broadcast information in RRC message in block 1010. For example, if the indication has indicated the UE cannot receive the broadcast information in target cell or the dedicated signaling for SIB delivery is needed, then it includes the broadcast information in the Handover command information in the HANDOVER REQUEST ACKNOWLEDGE message as in block 1012. In some embodiments, the basestation-CU may also decide to deliver the broadcast information to UE via dedicate RRC signaling after a successful handover. In block 1014, the target basestation sends RRC RECONFIGURATION message to the UE. The HO command may include the broadcast information (e.g., at least one of the SIB information) of target cell in HO command information within the message. In this way, the UE can receive the broadcast information via the RRC message (e.g., RRC RECONFIGURATION), even if the UE cannot receive these information broadcast by the target cell. In block 1016, the handover (HO) is performed for the UE from source basestation to the target basestation.

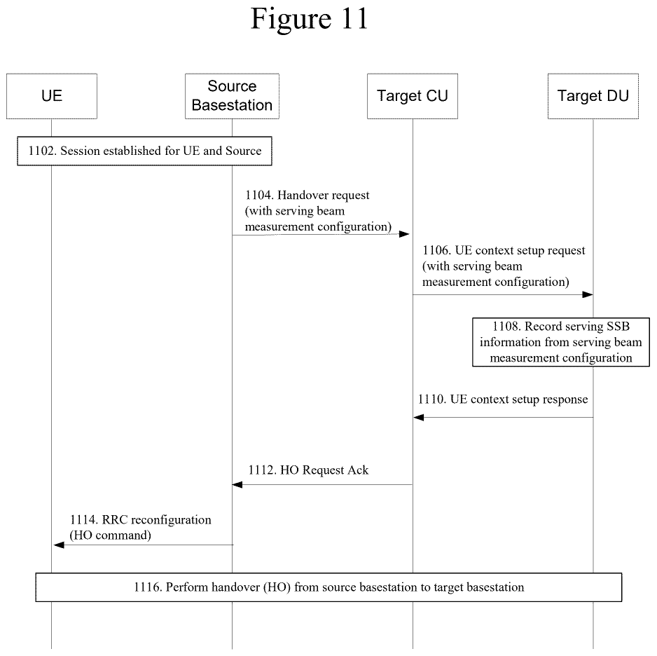

FIG. 11 shows an embodiment of UE mobility between different basestations with serving beam measurement configuration information. In block 1102, the UE establishes a Packet Data Unit (PDU) session between the UE, the source basestation and the target CU basestation.

During the UE mobility, the source basestation identifies the target basestation for handover, and the source basestation is aware of which beam(s) are switched off in the target cell of target basestation. If the source basestation assumes the UE can move to the area of some deactivated beam(s) coverage in the target cell, then the basestation sends the handover request message via Xn interface to the target basestation in block 1104. The handover request may include the serving beam measurement configuration information in the message.

After receiving the handover request message, the basestation-CU of the target basestation sends a UE CONTEXT SETUP REQUEST message to the target basestation-DU in block 1106. The target cell locates the target basestation-DU. This is a request for allocating resources for the UE handover and setup UE context, and may include the Mobility Assistance Information in the message. The Mobility Assistance Information examples are described with respect to FIGS. 7-8 and illustrated separately in FIGS. 9-11. In block 1106, the request includes serving beam measurement configuration information.

After receiving the UE CONTEXT SETUP REQUEST message, the basestation-DU allocates resource for this UE in the target cell, and establishes UE context in the basestation-DU. With the Serving Beam Measurement Configuration received, the basestation-DU shall record serving SSB information according to this information in block 1108. In one example, if there is an indication to indicate only one last serving SSB is needed to report, the basestation-DU only records only one last serving SSB index. In another example, if there is an indication to indicate one or more SSBs has served the UE in a period time are needed to report, the basestation-DU shall record the serving SSB periodic. In another example, if there is indication to indicate the UE staying time in each reported serving SSB is needed to report, the basestation-DU shall record the UE staying time in each serving SSB. In block 1110, the basestation-DU sends the UE CONTEXT SETUP RESPONSE message to the basestation-CU. After receipt of the UE CONTEXT SETUP RESPONSE message, the HANDOVER REQUEST ACKNOWLEDGE message is sent as in block 1112.

In block 1114, the target basestation sends RRC RECONFIGURATION message to the UE. The HO command may include the broadcast information (e.g., at least one of the SIB information) of target cell in HO command information within the message. In this way, the UE can receive the broadcast information via the RRC message (e.g., RRC RECONFIGURATION), even if the UE can not receive these information broadcast by the target cell. In block 1116, the handover (HO) is performed for the UE from source basestation to the target basestation.

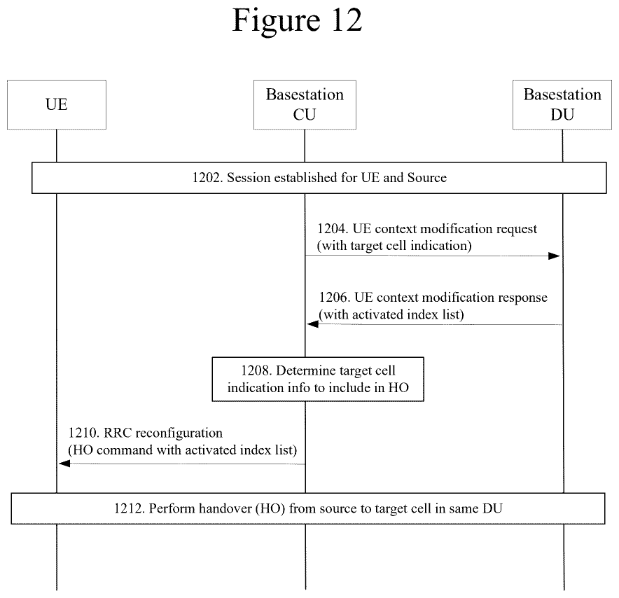

FIGS. 9-11 illustrate an embodiment with UE context setup communications with different mobility assistance information communicated. FIGS. 12-14 illustrate an embodiment with UE context modification communications. UE context modification communications may be used when the UE context already exists in the basestation-DU (i.e. the target cell and source cell are in the same basestation-DU). Conversely, the embodiment in FIGS. 9-11 is needed when the UE context is not existing in the new target basestation-DU.

FIG. 12 shows an embodiment of UE mobility within intra-DU basestations with target cell indication information. In block 1202, the UE establishes a Packet Data Unit (PDU) session between the UE, the basestation, and the network. During the UE mobility, the basestation-CU decides the target cell for handover, which is in the same basestation-DU where the source cell is located. Since the UE context already exists in the basestation-DU, the basestation-CU sends the UE CONTEXT MODIFICATION REQUEST message to the basestation-DU in block 1204. The request is for allocating resources for UE handover in target cell and modifying the UE context. The request 1204 may include the target cell indication in the message. The target cell indication may be an SSB Index List To Activate, to indicate the target cell which beam(s) is/are needed to switch on. The basestation-CU is aware of which beam(s) are switched off in target cell of the basestation-DU. If the basestation-CU assumes the UE is possible to move to the area of some deactivated beam(s) coverage, then the basestation-CU may include this information in the message.

After receiving the UE CONTEXT MODIFICATION REQUEST message, the basestation-DU modifies the UE context and allocates resource for this UE in the target cell. When the target cell indication (SSB Index List To Activate) information is received, the basestation-DU shall switch on the beams indicated by this information, and include the Successfully Activated SSB Index List (to indicate which beam(s) is/are successfully activated) in the UE CONTEXT MODIFICATION RESPONSE message in block 1206. This can improve the rate of successful handovers.

After receiving the UE CONTEXT MODIFICATION RESPONSE message with the Successfully Activated SSB Index List, the basestation-CU decides which target cell indication info to included in the Handover (HO) command in block 1208. Pending the decision, the Successfully Activated SSB Index List is included in the RRC RECONFIGURATION message in block 1210. In block 1212, the handover (HO) is performed for the UE from the source cell to the target cell within the same basestation-DU.

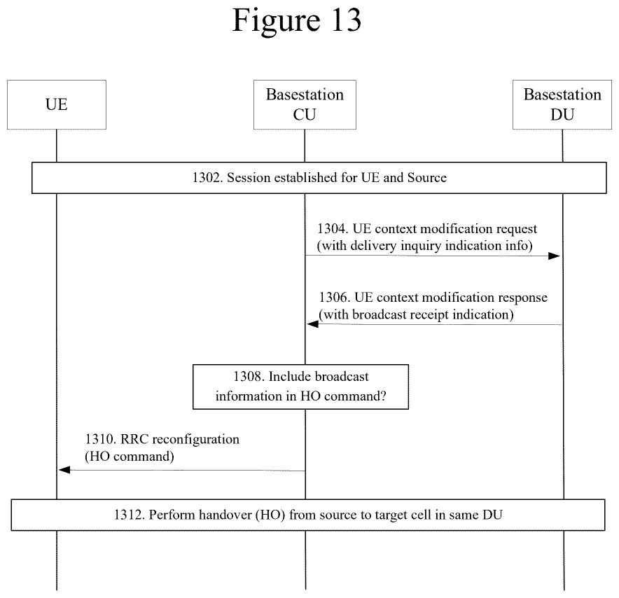

FIG. 13 shows an embodiment of UE mobility within intra-DU basestations with delivery inquiry indication information. In block 1302, the UE establishes a Packet Data Unit (PDU) session between the UE, the basestation, and the network. During the UE mobility, the basestation-CU decides the target cell for handover, which is in the same basestation-DU where the source cell is located. Since the UE context already exists in the basestation-DU, the basestation-CU sends the UE CONTEXT MODIFICATION REQUEST message to the basestation-DU in block 1304. The request is for allocating resources for UE handover in target cell and modifying the UE context. The request 1304 may include delivery inquiry indication information in the message. The delivery inquiry indication may be a SIB Delivery Inquiry Indication, to request reporting whether the UE can receive broadcast information in target cell or not.

After receiving the UE CONTEXT MODIFICATION REQUEST message, the basestation-DU modifies the UE context and allocates resource for this UE in the target cell. When the delivery inquiry indication (SIB Delivery Inquiry Indication) information is received, the basestation-DU determines whether the UE can receive broadcast information in a target cell. The context modification response in block 1306 may include a broadcast receipt indication. Specifically, the basestation-DU shall include the SIB Delivery Needed Indication (to indicate whether the UE can receive the broadcast information in a target cell or not; or to indicate whether the dedicated signaling for SIB delivery is needed) in the UE CONTEXT MODIFICATION RESPONSE message in block 1306.

After receiving the UE CONTEXT MODIFICATION RESPONSE message with the broadcast receipt indication or SIB Delivery Needed Indication, the basestation-CU decides whether to deliver the broadcast information in an RRC message in block 1308. For example, when the indication has indicated the UE cannot receive the broadcast information in the target cell or the dedicated signaling for SIB delivery is needed), then the broadcast information or SIB information is included with the Handover command information in the RRC RECONFIGURATION message in block 1310. In some embodiments, the basestation-CU can also decide to deliver the broadcast information to UE via dedicate RRC signaling after a successful handover. The HO command may include the broadcast information (e.g., at least one of the SIB information) of target cell in HO command information within the message. In this way, the UE can receive the broadcast information via the RRC message (e.g., RRC RECONFIGURATION), even if the UE cannot receive these information broadcast by the target cell. In block 1312, the handover (HO) is performed for the UE from the source cell to the target cell within the same basestation-DU.

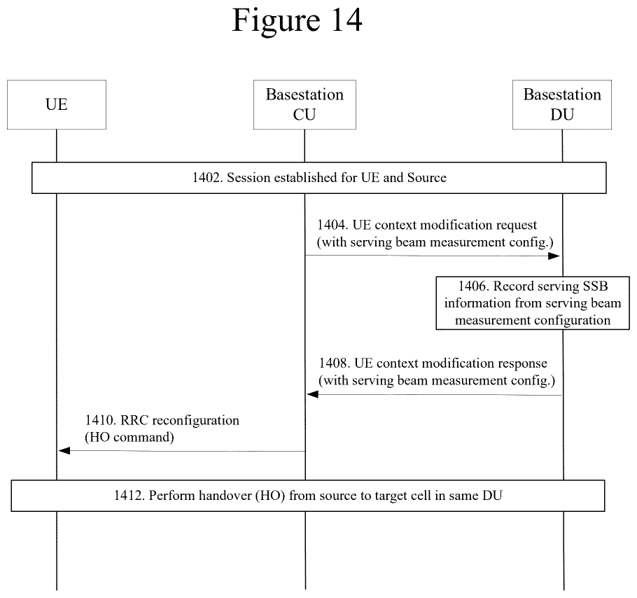

FIG. 14 shows an embodiment of UE mobility within intra-DU basestations with serving beam measurement configuration information. In block 1402, the UE establishes a Packet Data Unit (PDU) session between the UE, the basestation, and the network. During the UE mobility, the basestation-CU decides the target cell for handover, which is in the same basestation-DU where the source cell is located. Since the UE context already exists in the basestation-DU, the basestation-CU sends the UE CONTEXT MODIFICATION REQUEST message to the basestation-DU in block 1404. The request is for allocating resources for UE handover in target cell and modifying the UE context. The request 1404 may include the serving beam measurement configuration information in the message. The Serving Beam Measurement Configuration may include at least one of following: an indication to request reporting only one last serving SSB; an indication to request reporting one or more SSBs serving the UE in a period time; or an indication to request reporting the UE staying time in each reported serving SSB.

After receiving the UE CONTEXT MODIFICATION REQUEST message, the basestation-DU modifies the UE context and allocates resource for this UE in the target cell. When the Serving Beam Measurement Configuration information is received, the basestation-DU shall record serving SSB information according to this information in block 1406. For example, if there is an indication to indicate only one last serving SSB is needed to report, the basestation-DU only records only one last serving SSB index. In another example, if there is an indication to indicate one or more SSBs has served the UE in a period time are needed to report, the basestation-DU shall record the serving SSB periodic. In another example, if there is indication to indicate the UE staying time in each serving SSB is needed to report, the basestation-DU shall record the UE staying time in each serving SSB. In block 1408, the basestation-DU sends the UE CONTEXT MODIFICATION RESPONSE message to the basestation-CU.

In block 1410, the basestation-CU sends RRC RECONFIGURATION message to the UE. The HO command may include the broadcast information (e.g., at least one of the SIB information) of target cell in HO command information within the message. In this way, the UE can receive the broadcast information via the RRC message (e.g., RRC RECONFIGURATION), even if the UE can not receive these information broadcast by the target cell. In block 1412, the handover (HO) is performed for the UE from the source cell to the target cell within the same basestation-DU.

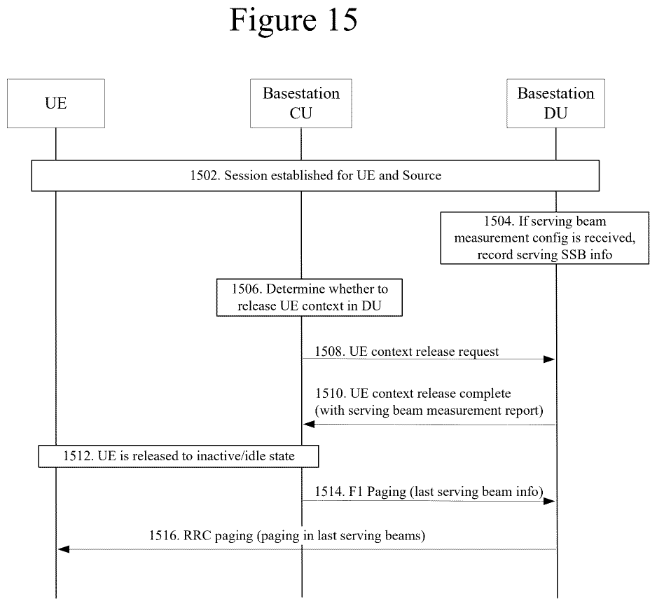

FIG. 15 shows an embodiment of paging a UE with restricted mobility within intra-DU basestations. In block 1502, the UE has established a PDU session(s) among UE, basestation and the core network (CN). In block 1504, if the basestation-DU has received the Serving Beam Measurement Configuration when UE context is established/modified in the basestation-DU (e.g. as illustrated in FIG. 11 and FIG. 14), the basestation-DU shall record serving SSB information according to Serving Beam Measurement Configuration. In one example, if there is an indication to indicate only one last serving SSB is needed to report, the basestation-DU only records only one last serving SSB index. In another example, if there is an indication to indicate one or more SSBs has served the UE in a period time are needed to report, the basestation-DU shall record the serving SSB periodic. In another example, if there is indication to indicate the UE staying time in each serving SSB is needed to report, the basestation-DU shall record the UE staying time in each serving SSB. In block 1506, the basestation-CU decides whether to release the UE context in the basestation-DU. This may include whether to release the UE to RRC IDLE or INACTIVE. In block 1508, the basestation-CU sends a UE CONTEXT RELEASE REQUEST message to the basestation-DU. After the basestation-DU receives the UE CONTEXT RELEASE REQUEST message, the basestation-DU releases the UE context in block 1510.

If the Serving Beam Measurement Configuration is received before, such as when the UE context is established/modified in the basestation-DU, the basestation-DU shall include the Serving Beam Report in the UE CONTEXT RELEASE COMPLETE message in block 1510. The Serving Beam Report may include: one last serving SSB index; the serving SSB index list, to indicate one or more SSBs has served the UE in a period time; and/or UE staying time in each reported serving SSB. In other embodiments, the basestation-DU may include the one last serving SSB index in the UE CONTEXT RELEASE COMPLETE message in block 1510.

In block 1512, the UE is released to an inactive or idle state (e.g. the RRC INACTIVE or RRC IDLE state). If the basestation-CU decides to page the UE (e.g., for data transmission), the basestation-CU sends the F1 paging message to basestation-DU via F1 interface in block 1514. The paging may include at least one of the following: one last serving SSB index in last visited cell; last serving SSB index list (indicating one or more serving SSB in a period time) in the last visited cell; one last serving SSB index in each paging cell; and/or last serving SSB index list (indicating one or more serving SSB in a period time) in each paging cell. The basestation-DU sends the RRC paging message to page the UE in block 1516. It may use the received serving SSB information into consideration (e.g., only pages the UE via the indicated last serving SSB in last visited cell or paging cell). The UE can be paged quickly and energy consumption on the RAN can be reduced.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless communication method comprising:
receiving, at a basestation distributed unit (DU), a target cell indication; and
activating, by the basestation DU, one or more beams indicated by the target cell indication.

2. The method of claim 1, wherein the target cell indication comprises a synchronization signal block (SSB) index list to activate.

3. The method of claim 1, wherein the target cell indication is provided by a basestation centralized unit (CU); and/ or the basestation CU receives the one or more beams that were successfully activated from the basestation DU.

4. (canceled)

5. The method of claims 1, wherein a SSB index list to activate is included in a handover request message from another basestation.

6. The method of claims 1, wherein the successfully activated beam(s) are included in a handover acknowledge message response by a basestation centralized unit (CU).

7. The method of claims 1, wherein the receiving and activating are part of a context setup or context modification communications.

8. A wireless communication method comprising:
receiving, at a basestation distributed unit (DU), a delivery inquiry indication information sent by a basestation centralized unit (CU) that indicates to report whether a user equipment (UE) can receive broadcast information in a target cell; and
determining, by the basestation DU, whether a user equipment (UE) can receive broadcast information in a target cell based on the delivery inquiry indication information.

9. The method of claim 8, wherein the delivery inquiry indication information comprises a system information block (SIB) delivery inquiry indication.

10. The method of claim 8, comprising:
sending, by a basestation DU, a broadcast receipt indication to a basestation CU, wherein the broadcast receipt indication indicates whether the UE can receive the broadcast information in the target cell or whether dedicated signaling for SIB delivery is needed.

11. The method of claims 8, wherein the basestation CU determines a type of SIB delivery to the UE based on the broadcast receipt indication.

12. The method of claims 8, wherein the basestation CU delivers at least one of SIB block information to the UE via dedicated RRC signaling after a successful handover.

13. The method of claims 8, wherein the receiving and sending are part of a context setup or context modification communications.

14. A wireless communication method comprising:
receiving, at a basestation distributed unit (DU), a serving beam measurement configuration; and
recording serving synchronization signal block (SSB) information based on the serving beam measurement configuration.

15. The method of claim 14, wherein the serving beam measurement configuration comprises at least one of:
an indication to request reporting of a last serving SSB;
an indication to request reporting one or more SSBs serving the UE in a defined period time; or
an indication to request reporting of a UE staying time for each serving SSB.

16. The method of claim 14, wherein the basestation DU reports the recorded serving SSB information to a basestation centralized unit (CU).

17. The method of claims 14-16, wherein when the serving beam measurement configuration is not received, the basestation DU reports on a one last serving SSB index to the basestation CU.

18. The method of claim 16, wherein the basestation DU includes the report in an UE CONTEXT RELEASE COMPLETE message during the UE context release procedure.

19. The method of claim 14, wherein the receiving is during user equipment (UE) context setup or UE modification.

20. A wireless communications apparatus comprising a processor and a memory, wherein the processor is configured to read code from the memory and implement a method recited in claim 1.

21. A computer program product comprising a computer-readable program medium code stored thereupon, the code, when executed by a processor, causing the processor to implement a method recited in of claim 1.
